(19) United States
(12) Patent Application Publication
(10) Pub. No.: US 2026/0135021 A1
(43) Pub. Date: May 14, 2026

(54) Pass-Thru Electrical Devices and Methods

(71) Applicant: Halliburton Energy Services, Inc., Houston, TX (US)

(72) Inventors: Christopher C Hoelscher, Houston, TX (US); Matthew Craig Mlcak, Houston, TX (US); Stuart Michael Wood, Houston, TX (US)

(73) Assignee: Halliburton Energy Services, Inc., Houston, TX (US)

(21) Appl. No.: 18/947,938

(22) Filed: Nov. 14, 2024

(51) Int. Cl. H01B 17/30

(52) U.S. Cl. CPC H01B 17/303

(57) ABSTRACT

An electrical pass-thru device for connecting with a corresponding electrical receptacle of, and transmitting an electrical signal to, a downhole tool. The electrical pass-thru device includes a body including a first end and a second end. The electrical pass-thru device also includes an electrical contact at the second end configured to transmit the electrical signal through the corresponding electrical receptacle to the downhole tool. The electrical pass-thru device also includes a sealing insulator extending along and at least partially covering the body and configured to deform from an initial state to a deployed state, thereby forming a sealed interface with the corresponding electrical receptacle that is adapted to receive the electrical signal.

### BACKGROUND

Wellbores may be created through various drilling techniques to access hydrocarbons in downhole formations for production. Wellbores may be accessed and worked on by various tools during and after drilling, which requires communication with (e.g., sending control signals to) the downhole wellbore tools. Control signals may be passed from the surface down the wellbore to the tooling.

Techniques for transmitting the signal from the surface to the downhole tooling may involve various moving components, high pressures and temperatures, long distances, and other challenges presented by the wellbore, environment, and/or tooling limitations. If sending the control signal fails, additional downtime, expense and risks may result. For example, some downhole tooling may include a perforating gun, which may require removal and disassembly (with undetonated explosive charges) if sending the control signal fails.

Existing electrical connectors or bulkheads used to transmit an electrical signal to a downhole wellbore tool, such as a perforating gun, are typically constructed of a brass conductor that is insulated on the outside with a Polyether ether ketone (“PEEK”) material, which provides a corresponding structure(s) that house one or more O-ring(s) that form a sealed interface with a mating bore or housing (e.g., a corresponding electrical receptacle).

However, the PEEK material adds substantial cost to the electrical connector or bulkhead. Furthermore, the O-ring(s) that form the sealed interface are susceptible to damage, which may cause the sealed interface formed by the O-ring(s) to fail.

### BRIEF DESCRIPTION OF THE DRAWINGS

Aspects of the disclosure are described with reference to the following figures. The same or sequentially similar numbers are used throughout the figures to reference like features and components. The features depicted in the figures are not necessarily shown to scale. Certain features may be shown exaggerated in scale or in somewhat schematic form, and some details of elements may not be shown in the interest of clarity and conciseness.

FIG. 1 is block diagram schematic view of a tooling assembly that includes an electrical pass-thru device interfacing with an electrical receptacle of a downhole wellbore tool, according to an example of the present disclosure.

FIG. 2A is a schematic cross-sectional view of an electrical pass-thru device for transmitting an electrical signal to a downhole wellbore tool, according to an example of the present disclosure.

FIG. 2B is a schematic cross-sectional view of the electrical pass-thru device of FIG. 1A in a deployed state, according to an example of the present disclosure.

FIG. 3A is a schematic cross-sectional view of an electrical pass-thru device for transmitting an electrical signal to a downhole wellbore tool, according to an example of the present disclosure.

FIG. 3B is a schematic cross-sectional view of the electrical pass-thru device of FIG. 2A in a deployed state, according to an example of the present disclosure.

FIG. 4 is a flow chart of a method for separating and removing debris from a wellbore, according to an example of the present disclosure.

### DETAILED DESCRIPTION

The present disclosure describes improved electrical pass-thru device(s) and method(s), such as an electrical connection or bulkhead, for transmitting an electrical signal to a downhole wellbore tool. The pass-thru device comprises a conductor and a deformable electrical insulator that compresses and deforms to form a seal with a corresponding electrical receptacle adapted to receive the electrical signal.

As noted in the Background, existing electrical connectors or bulkheads used to transmit electrical signals to downhole wellbore tools (e.g., perforating guns), are typically constructed of a brass conductor that is insulated on the outside with a PEEK material, which utilizes O-ring(s) to form a sealed interface with a mating bore or housing (e.g., a corresponding electrical receptacle). However, the O-ring(s) are susceptible to damage and form a weaker sealed interface than the pass-thru device(s) described herein. Additionally, the PEEK material is typically more expensive than several suitable materials of the sealing insulator described herein.

The present disclosure presents a novel electrical pass-thru device, system, or apparatus that comprises a sealing insulator that deforms from an initial state to a deployed state when positioned and secured in a mating bore, housing or corresponding electrical receptacle that is adapted to receive an electrical signal being transmitted by the electrical pass-thru device. The sealing insulator has material and mechanical properties such that the insulator compresses and/or deforms when advanced into and positioned within the corresponding electrical receptacle. The sealing insulator may further deform and compress when secured and retained within the electrical receptacle (e.g., via a retention nut).

The sealing insulator described herein advantageously replaces the function of both the (i) typical insulated layer (e.g., PEEK material layer) that electrically insulates the conductor and (ii) O-ring(s) that form a sealed interface with the corresponding electrical receptacle. Therefore, the sealing insulator described herein eliminates the need for separate O-ring(s) to form the sealed interface, which may further reduce the cost of the pass-thru device. For example, integrating a deformable elastomer as the sealing insulator reduces the cost of the pass-thru device as compared to existing bulkheads that utilize a PEEK insulation layer (PEEK material adds substantial cost to the electrical connector or bulkhead) and separate O-rings, which add an additional component cost to construction of the pass-thru device, such as a bulkhead.

Additionally, the sealing insulator described herein advantageously provides a larger surface area at the sealed interface than other existing electrical pass-thru devices that use one or more O-rings to form a seal. The sealed interface is formed by the interaction of the deformable insulator and internal structure of the corresponding electrical receptacle. In one or more examples, the majority or the entirety of an outside surface of the sealing insulator makes up the surface area at the sealed interface, which is a much larger sealed interface than other existing devices utilizing O-ring(s) to create the seal. The larger sealed interface also advantageously allows the electrical pass-thru device(s) described herein to maintain the sealed interface even if a portion of the sealing insulator has been damaged.

For example, the sealing insulator described herein may be damaged either during use, transport or by an unintended manufacturing defect. Specifically, the damage may include surface blemishes, scratches, cuts, abrasions, or other defects. Because of the larger amount of contiguous material that forms the sealing insulator (as compared to O-ring seals), the sealing insulator is still able to form and maintain the sealed interface in the deployed state. Additionally, depending on the specific technique for applying the sealing insulator, in the examples where the sealing insulator is overmolded onto the body, the sealing insulator may have additional resilience to damage or defects compared to O-rings that simply slide over the body. Conversely, an O-ring is susceptible to failure if it experiences and/or includes similar surface blemishes, scratches, cuts, abrasions, or other defects. Ensuring that the electrical pass-thru device can form and maintaining the sealed interface, even when a portion of the sealing insulator is damaged, improves the reliability of the electrical pass-thru device and reduces the likelihood of a seal failure, which may result in damage to downstream tool components.

Furthermore, the size, shape and outer surface profile of the sealing insulator is advantageously configured to induce compression and deformation as the electrical pass-thru device is advanced into and positioned within the corresponding electrical receptacle. For example, the sealing insulator may include parallel portions, sloped or slanted portions, frustoconical portions, rounded portions, and/or curved portions. A parallel portion may indicate that outer surface of the sealing insulator is parallel to the underlying conductor in that section of the device (e.g., a cylindrical conductor with the sealing indicator positioned over the conductor as a tubular sleeve).

It should be appreciated that the sealing insulator may be sized and shaped according to the corresponding electrical receptacle that the electrical pass-thru device is intended to interface with to ensure that the surface geometry of the sealing insulator is configured to form an appropriate sealed interface with the electrical receptacle it is designated to plug into. In some examples, the surface geometry of the sealing insulator may depend on the size, shape, features, and geometry of the receptacle (e.g., mating bore or housing).

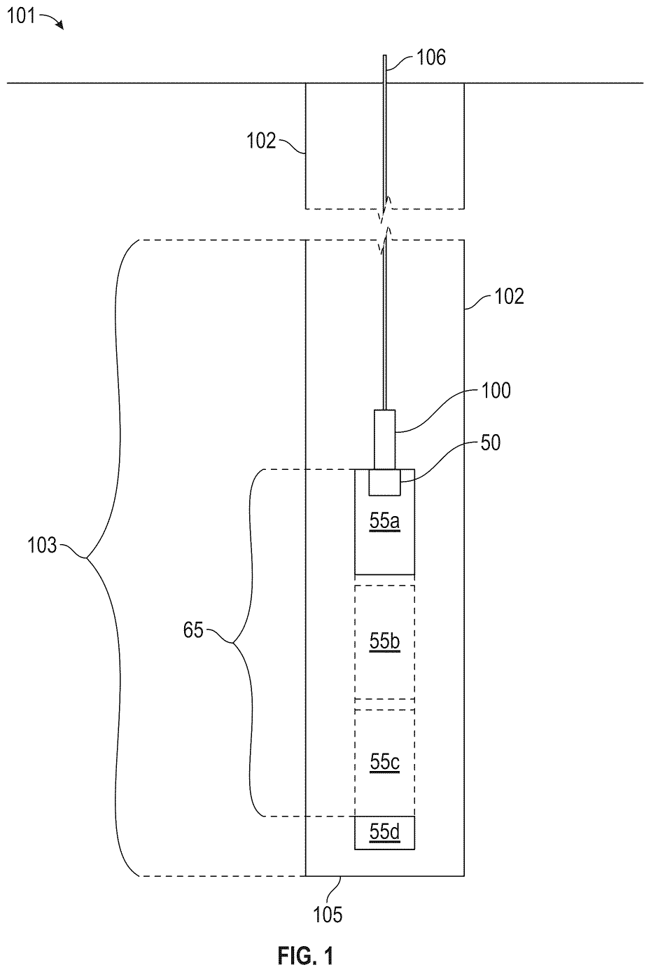

Turning now the figures, FIG. 1 is a block diagram schematic view of a tooling assembly 101 that includes an electrical pass-thru device 100 connected to a corresponding electrical receptacle 50 of a tool, such as a downhole wellbore tool 55a-b, generally referred to herein as downhole wellbore tool 55 or wellbore tool 55. Once connected, the electrical pass-thru device 100 is configured to transmit an electrical signal to the tool, such as a downhole wellbore tool 55. In the illustrated example, the electrical pass-thru device 100 is used as part of a downhole tooling assembly 101 run on a line or wire 106, which may also be referred to as a wireline or an electric wire. In the example, the debris SAS apparatus is a tool run on a wireline (e.g., line or wire 106), but it should be appreciated that the examples disclosed herein may be used or may be modified for use with other downhole conveyance techniques.

In the illustrated example, the tooling assembly 101 may include multiple tools or wellbore tools 55 (e.g., wellbore tools 55a-d). The wellbore tool(s) 55 may be a setting tool, one or more perforating guns, etc. For example, the tooling assembly 101 may include three perforating guns 55a, 55b and 55c. The tooling assembly may also include a setting tool 55d, such as a plug. It should be appreciated that many of the examples described herein reference a wellbore or wellbore tool(s) 55. However, it should be appreciated that the examples may apply to other tools and tooling, in addition to wellbore tools and tooling.

Even though the example illustrated in FIG. 1 includes up to three chambers downhole wellbore tools 55, it should be appreciated that a tooling assembly 101 may include more or less wellbore tools 55 than illustrated in FIG. 1. Additionally, the tooling assembly 101 may include multiple wellbore tools 55 of the same type (e.g., multiple perforating guns 55a). In other examples, different types or configurations of a wellbore tool 55 may make up the tooling assembly 101. For example, one of the wellbore tools 55 may be a perforating gun 55a with a first arrangement of discharge locations while another of the wellbore tools 55 is a perforating gun 55b with a second arrangement (different from the first arrangement) of discharge locations. The various tooling configurations for the tooling assembly 101 may depend on environmental, wellbore, and other tooling conditions and characteristics.

In the example illustrated in FIG. 1, the tooling assembly 101 may be a perforating gun assembly, which may be advanced down the wellbore 102, typically through a horizontal section 103, towards the end 105 of the wellbore 102. The perforating gun assembly may include multiple perforating guns (e.g., wellbore tools 55a, 55b and/or 55c). In an example, a setting tool 55d may be positioned at the end of the perforating gun assemblies 55a-c.

Once properly positioned with the section 103 of the wellbore 102, an electrical signal may be sent along wire 106, through the electrical pass-thru device 100 and to a connector (e.g., electrical connector) within the electrical receptacle associated with a downhole wellbore tool 55, such as a perforating gun. Specifically, a controller at the surface may send an electrical signal to the downhole wellbore tool. Once the signal is transmitted to the perforating gun, the signal may be used to trigger a detonator to detonate the charges at the various discharge locations about the perforating gun.

The detonated charges may create perforations within a wellbore casing to assist with the recovery of hydrocarbons from the wellbore 102. For example, the perforations formed in the casing and the adjacent earth create paths for hydrocarbons to flow through the perforations and into the wellbore 102. Then, a fracturing operation may be completed to assist with hydrocarbon recovery. It should be appreciated that various fracturing techniques or processes may be used to assist with the hydrocarbon recovery.

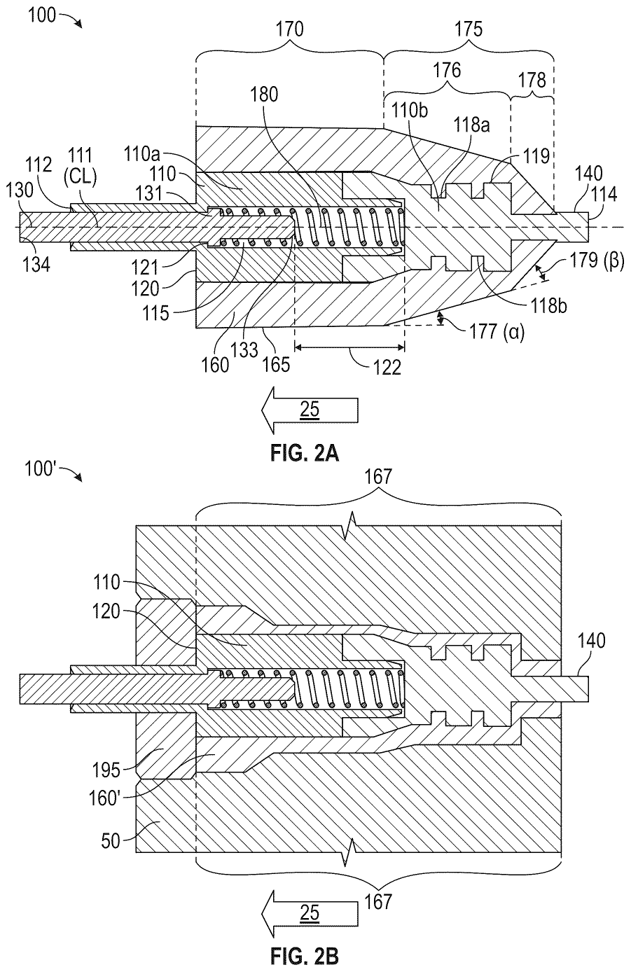

The perforating guns may be advanced to other sections of the wellbore 102 to perform subsequent perforation operations. At various stages throughout the process, a setting tool 55d, such as a plug, may be set, which is typically used for one or more isolation tasks. The setting tool 55d may be used as a permanent installation (e.g., in a permanent configuration) or as a retrievable tool (e.g., retrievable configuration) that temporarily isolates a section (e.g., a lower portion of the wellbore 102) from production or another operation conducted in another section or zone of the wellbore 102. Both the setting tool and/or the sealed interface (see FIG. 2B and corresponding description below) formed by the electrical pass-thru device 100 are configured to form a seal itself, form a seal with an adjacent component, seal components that are positioned downstream of the pass-thru device 100, or the like. Additionally, the sealed interface and/or setting tool 55d are configured to withstand the high pressures of downhole operations and applications. For example, the isolation task and/or seal created by the isolation task may be able to withstand the pressures related to perforating gun charge detonations, fracturing activities, and other downhole wellbore activities performed during hydrocarbon recovery.

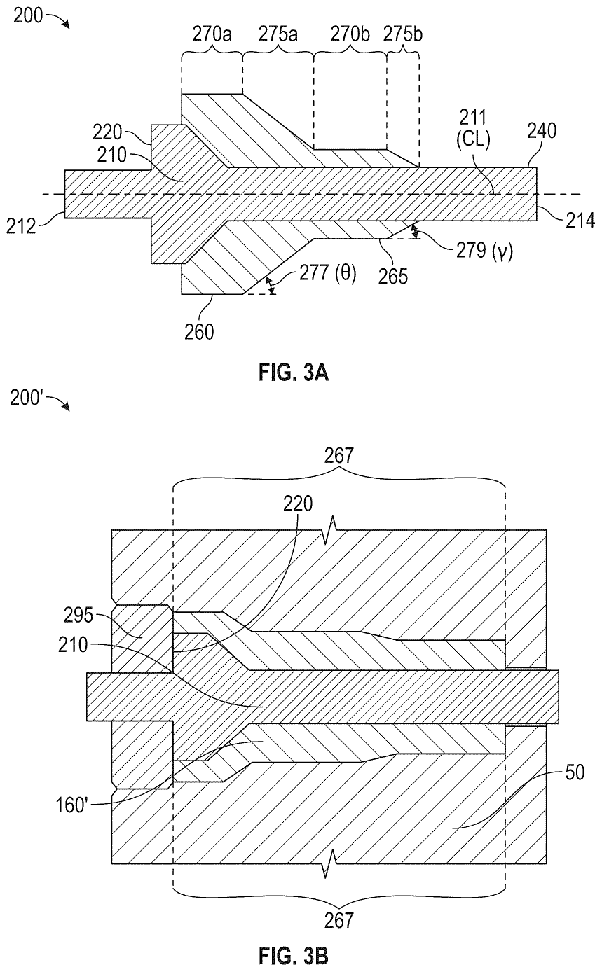

Any of the downhole wellbore tools 55 described herein may include electrical receptacles, connectors, and/or connectors that are configured to create an electrical coupling between the wire 106, the electrical pass-thru device 100 and the wellbore tool 55. Some non-limiting examples of the electrical receptacles, connectors, and/or connectors are illustrated in FIGS. 2B and 3B, however it should be appreciated that any corresponding electrical receptacle, or the like, may have additional and/or different features than those illustrated and described herein.

FIG. 2A illustrates a schematic cross-sectional view of an electrical pass-thru device 100 for transmitting an electrical signal to a downhole wellbore tool. In the illustrated example, the electrical pass-thru device 100, which may be an electrical connector such as a bulkhead, includes a body 110 that has a first end 112 and a second end 114. The electrical pass-thru device 100 also includes an electrical contact 140 at the second end 114 and a sealing insulator 160 at least partially covering the body 110. The body 110 may be formed as an elongated body and may be made, at least partially from conducting material such that the body serves as a conductor that is capable of receiving and transmitting an electrical signal.

In the example, the body 110 may be formed as an elongated body and may be made, at least partially from, conducting material such that the body 110 serves as a conductor. As used herein, the body 110 may be referred to generally as conductor 110. The body 110 (e.g., conductor) may be a single piece or component (e.g., monolithic, unitary, homogeneous). In other examples, like the one illustrated in FIG. 2A, the body 110 (e.g., conductor) may include multiple pieces and/or components. For example, body 110 may include a first body portion 110a and a second body portion 110b that are configured to join together to form the body 110. The body 110 may also include a mounting surface 120, which may surface as a mating or interfacing surface for a retention nut (see retention nut 195 of FIG. 2B).

The electrical contact 140, positioned about the second end 114 of the body 110 (e.g., conductor), is configured to transit an electrical signal conveyed through the body 110 to a corresponding electrical connector and ultimately to the downhole wellbore tool. The electrical contact 140 may be a contact pin that has a contact head or contact portion at the second end 114. In some examples, the contact head or contact portion at the second end 114 may include an enlarged contact surface, similar to the head of a nail. In an example, the contact head, contact portion and/or second end 114 may be sized, shaped, or otherwise configured to facilitate an electrical coupling or connection with the corresponding electrical receptacle 50 (e.g., socket). In the illustrated example, the electrical contact 140 may be a stationary contact that is fixed in relation to the body 110.

In another example, the electrical contact 140 may be movable (e.g., rotatable, spinable, bendable, pivotable, translatable, etc.). For example, the electrical contact 140 may rotation or spin about the CL 111. In some examples, the electrical pass-thru device 100 may include another electrical contact 140 that is movable and/or translatable, such as a movable plunger 130. The movable plunger 130 and biasing member 180 may provide a deployment tolerance buffer 122 that allows an electrical connection to be made for a range of advanced positions of the electrical pass-thru device 100. For example, the additional length of travel (e.g., deployment tolerance buffer 122) afforded by the buffer 122 for the electrical pass-thru device 100, as the electrical pass-thru device 100 is advanced down the wire 106, advantageously compensates for what may otherwise be a tight tolerance stack-up.

The movable plunger 130 may have a plunger head with top surface 133 and a plunger brake 131 spaced apart from the top surface 133. The side (e.g., contact surface 134) opposite the plunger head or top surface 133 may serve as an electrical contact, similar to electrical contact 140. As shown in FIG. 2A, the body 110 includes a plunger stop 121, which is a shelf in the illustrated example that interfaces and interacts with plunger brake 131. For example, biasing member 180, which may be a compression spring, may sit on and engage the plunger brake 131 to bias the plunger 130 to the left (e.g., in the direction of arrow 25). This biasing member 180 may provide resistance against further lateral advancement of the electrical pass-thru device 100 while maintaining electrical communication between the plunger 130 and body 110 throughout the entire range of motion within the deployment tolerance buffer 122.

Then, as the electrical pass-thru device 100 is advanced down or along the wire 106 to form a connection with a corresponding electrical receptacle 50 (see FIG. 2B) of a downhole wellbore tool, the signal sent to the pass-thru device for transmission may advantageously be sent through the device from contact surface 134 to the second end and/or electrical contact 140 regardless of whether the electrical pass-thru device 100 is deployed too far, but still within the deployment tolerance buffer 122. Therefore, the plunger 130, biasing member 180 and body 110 are able to cooperate to provide deployment flexibility and additional buffers within the tolerance stack-up, which advantageously avoids failure, damage, and downtime.

The ability of one or more of the electrical contact(s) 140 and plunger 130 to rotate, spin, bend, pivot, translate or otherwise move advantageously compensates for any twisting, overextension or otherwise mispositioning of the wire 106, which may prevent the wire 106 and/or electrical pass-thru device 100 from functioning properly and may cause the wire 106 and/or the electrical pass-thru device 100 to snap, become unattached, uncouple, break and/or experience any other damage from unintended movements during deployment and operation.

The body or conductor 110 may include one or retention features that are adapted to provide additional surface area and structure for the sealing insulator 160 to bond to, which will be described in more detail below. The retention features may be a groove, trough, cavity, channel, or the like (e.g., retention channels 118a, 188b) as well as a protrusion, barb, lip, fin, or the like (e.g., retention protrusion(s) 119). In the illustrated example, the body or conductor 110 includes two circular ring-shaped retention channels 118a and 118b and two circular ring-shaped retention protrusions 119. It should be appreciated that the conductor, such as body 110 may include more retention features or less retention features than those illustrated in FIGS. 2A-2B. Similarly, the retention features may have a different size, shape or configuration than that shown in the illustrated examples.

The various notches and grooves formed by the retention features advantageously provide additional boding surfaces and paths, and in some examples a tortuous path, that the sealing insulator material may flow into and/or through during the overmolding process. These additional bonding surfaces and/or paths advantageously enhances the bond between the sealing insulator and the conductor (e.g., body 110). In other examples, the surface of the conductor (e.g., body 110) may include surface etching or other surface abrasions to improve the bond between the sealing insulator 160 and the body 110.

The sealing insulator 160 is configured to deform from an initial state illustrated in FIG. 2A to a deployed state as illustrated in FIG. 2B, which is a schematic cross-sectional view of the electrical pass-thru device of FIG. 2A in a deployed state (e.g., deployed within a corresponding electrical receptacle 50, such as a mating bore or housing of an electrical connector associated with a downhole wellbore tool). The sealing insulator 160 in the deployed state (see FIG. 2B) is referred to as sealing insulator 160′ to indicate that the sealing insulator 160′ is compressed and/or deformed. When in the deployed state, the sealing insulator 160′ forms a sealed interface 167 with a corresponding electrical receptacle 50. The sealed interface 167 is configured to seal off components positioned downstream of the electrical pass-thru device 100 during downhole operations and applications. For example, the sealed interface 167 may be configured to withstand the high pressures experienced during downhole drilling, perforating and/or fracturing operations.

The sealed interface 167 is an interface formed between the sealing insulator 160 (note that the sealing insulator 160′ is in the deployed state when the sealed interface 167 is formed) and the corresponding electrical receptacle 50. More specifically, the sealed interface 167 is the interference-fit, press-fit or friction-fit interface formed between the portions of the outer surface area of the sealing insulator 160 that contact the outer surface area of the corresponding electrical receptacle 50.

The size, shape and geometry of the sealing insulator 160 may be configured to provide a predetermined tightness of fit or a predetermined strength of fit, which may depend at least partially on one or more of the compressibility, elasticity, density and/or other material properties of the sealing insulator 160, dimensions, sizes, shapes and/or interfaces of and/or between the sealing insulator 160 and the corresponding electrical receptacle 50. The predetermined tightness of fit or a predetermined strength of fit may also depend on the surface profile, surface texture, and/or material of the corresponding electrical receptacle 50. The surface interactions (e.g., forces, stresses, pressures) between the compressed sealing insulator 160′ and the outer facing surface of the electrical receptacle 50 create a friction-fit, which maintains the coupling through interactions, such as friction forces that oppose movement between the sealing insulator 160′ and the electrical receptacle 50.

The sealing insulator 160 may be over-molded onto the body 110. For example, the sealing insulator 160 may be applied to the body or conductor 110 through an injection molding process, which molds the sealing insulator material over top of the body 110 (e.g., conductor), which acts as a substrate that the sealing insulator material bonds to during the overmolding process. It should be appreciated that the sealing insulator 160 may be applied to the body 110 (e.g., conductor) via other manufacturing techniques other than overmolding.

The overmolding process may advantageously provide a sealing insulator that protects the underlying conductor or body 110 and creates a fluid-resistant seal over the portion of the underlying conductor that the sealing insulator covers. For example, the sealing insulator 160 may provide protection against vibrations and other contact interactions with other components, surfaces or structures of the wellbore or wellbore tooling.

In an example, the sealing insulator 160 is made from an elastomeric material that can include an electrically isolating elastomer. As examples, such an electrically isolating elastomer could include one or more of the following: silicone elastomers, ethylene propylene diene monomer (EPDM), neoprene, fluoroelastomers, polyurethane elastomers, natural rubber, or any suitable combinations thereof. Additionally, as illustrated in FIG. 1A, the sealing insulator 160 has a surface profile 165 which may include various portions, such as a cylindrical or parallel portion 170 and a sloped portion 175. In the illustrated example, the sloped portion 175 includes a first sloped portion 176 and a second sloped portion 178. It should be appreciated that the sealing insulator 160 may have different surface profile(s) 165 and/or geometries than those illustrated in the figures. For example, the sealing insulator 160 may include more or less cylindrical portion(s) 170 and/or sloped portion(s) 175. Furthermore, cylindrical portion(s) may be interspaced between sloped portion(s), one example of which is described in more detail below with respect to FIG. 3A.

In the illustrated example, the sealing insulator 160 extends along and at least partially covers the body 110. By extending along the body 110 from the mounting surface 120 to the electrical contact 140 near the second end 114, which advantageously provides a much larger sealed interface than other existing devices utilizing O-ring(s) to create the seal. The larger sealed interface (see sealed interface 167 of FIG. 2B) also advantageously allows the electrical pass-thru device(s) 100 described herein to maintain the sealed interface even if a portion of the sealing insulator 160 has been damaged. For example, the sealing insulator(s) 160 described herein may advantageously maintain functionality if there are surface blemishes, cuts, scrapes or other defects. Specifically, the electrical pass-thru device(s) 100 described herein may be able form a sealed interface with an electrical receptacle 50 even if damaged, which would otherwise cause an O-ring and the corresponding seal to fail.

In the example illustrated in FIG. 2A, the first sloped portion 176 slopes inward toward the centerline (“CL”) 111 of the body 110 at an angle (α) 177 and the second sloped portion 178 slopes further inward toward the CL 111 at an angle (β) 179. In the illustrated example, the angle (β) 179 is measured with respect to surface profile 165 in the first sloped portion 176. It should be appreciated that instead of distinct sloped portions (175, 176, 178) that slope inward at a constant angle, the sloped portions may be curved and may gradually curve inward toward CL 111 and have an ogive or bullet shape.

In an example, angle (α) 177 may range from five degrees to thirty-five degrees. In another example, angle (α) 177 may range from ten degrees to twenty degrees. In another example, angle (α) 177 may range from twelve degrees to sixteen degrees. Similarly, angle (β) 179 may range from five degrees to thirty-five degrees. In another example, angle (β) 179 may range from ten degrees to twenty degrees. In another example, angle (β) 179 may range from twelve degrees to sixteen degrees. Angles (α) 177 and (β) 179 may be the same and in other examples one of the angles (e.g., angle (β) 179) may be greater than the other angle (e.g., angle (α) 177). It should be appreciated that instead of distinct angled sections, the surface profile 165 may include smooth curves or other non-linear portions that form sloped portion(s) 175, 176, 178.

Once deployed and in the deployed state illustrated in FIG. 2A, the sealing insulator 160′ is configured to maintain the sealed interface (see sealed interface 167 of FIG. 2B) before, during and after operation of the downhole wellbore tool. For example, the downhole wellbore tool may be a perforating gun or a setting tool, which may create significant forces and pressures within the wellbore and on the wellbore tooling during use. However, the sealed interface 167 creates a friction-fit interface that advantageously resists movement and dislodgement from the downhole wellbore tool forces. Furthermore, after connection, the sealed interface 167 may be further maintained and strengthened by installing a retention nut (see retention nut 195 of FIG. 2B) over one end of the electrical pass-thru device 100. As a retention nut 195 is positioned over the body 110 and tightened, the retention nut 195 may press against mounting surface 120 and hold the mounting surface 120 or constrain the mounting surface 120, and thus the body 110 and/or electrical pass-thru device 100 from backing out of or moving backwards (e.g., in the direction of arrow 25).

FIGS. 3A and 3B illustrate another example of an electrical pass-thru device 200. Many of the features and components of the electrical pass-thru device 200 of FIG. 3A may have the same or similar shape, structure, form, function, and/or design as corresponding features and components of the electrical pass-thru device 100 of FIG. 2A. For example, electrical pass-thru device 200 may have the same or similar structure, form, function, and/or design as the electrical pass-thru device 100. Additionally, the body 210, first end 212, second end 214, mounting surface 220, electrical contact 240, and sealing insulator 260 may have corresponding structure, form, function, and/or design as the body 110, first end 112, second end 114, mounting surface 120, electrical contact 140, and sealing insulator 160 of the electrical pass-thru device 100 described above and illustrated in FIGS. 2A and 2B. The cylindrical portion(s) 270, 270a, and 270b may have the same or similar structure, form, function, and/or design as the cylindrical portion(s) 170 of the electrical pass-thru device 100 described above and illustrated in FIGS. 2A and 2B. Similarly, the sloped portion(s) 275, 275a, and 275b may have the same or similar structure, form, function, and/or design as the sloped portion(s) 175, 176, and 178 of the electrical pass-thru device 100 described above and illustrated in FIGS. 2A and 2B.

The angle(s) 277 and 279 may have the same or similar structure, form, function, and/or design as have corresponding structure, form, function, and/or design as the angles 177 and 179 of the electrical pass-thru device 100 described above and illustrated in FIGS. 2A and 2B. In the example illustrated in FIG. 3A, the sealing insulator 260 has a first cylindrical portion 270a, followed by a first sloped portion 275a, followed by a second cylindrical portion 270b and a second sloped portion 275b. The first sloped portion 275a slopes inward toward the centerline (“CL”) 211 of the body 210 at an angle (θ) 277 and the second sloped portion 275b slopes further inward toward the CL 211 at an angle (γ) 279. In the illustrated example, the angle (γ) 279 is measured with respect to the surface profile 265 in the second cylindrical portion 270b. It should be appreciated that instead of distinct cylindrical and sloped portions, the surface profile 265 may include curves or other non-linear portions instead of the distinct angled or sloped portions depicted in FIG. 3A.

In an example, angle (θ) 277 may range from five degrees to thirty-five degrees. In another example, angle (θ) 277 may range from ten degrees to twenty degrees. In another example, angle (θ) 277 may range from twelve degrees to sixteen degrees. Similarly, angle (γ) 279 may range from five degrees to thirty-five degrees. In another example, angle (γ) 279 may range from ten degrees to twenty degrees. In another example, angle (γ) 279 may range from twelve degrees to sixteen degrees. Angles (θ) 277 and (γ) 279 may be the same and in other examples one of the angles (e.g., angle (γ) 279) may be greater than the other angle (e.g., angle (θ) 277).

The example electrical pass-thru device 200 illustrated in FIGS. 3A and 3B does not include a plunger or biasing member that provide a tolerance buffer and the tolerance buffer may be provided and/or the tolerance stack-up may be otherwise compensated through another component, device and or technique.

The components illustrated in FIG. 3B and the corresponding description may apply to the components illustrated in FIG. 3B. For example, the sealed interface 267 formed between the sealing insulator 260′ and the corresponding electrical receptacle 50, the additional retention provided by retention nut 295, etc. may function the same as the sealed interface 167, sealing insulator 160′ and retention nut 195 of FIGS. 2A and 2B.

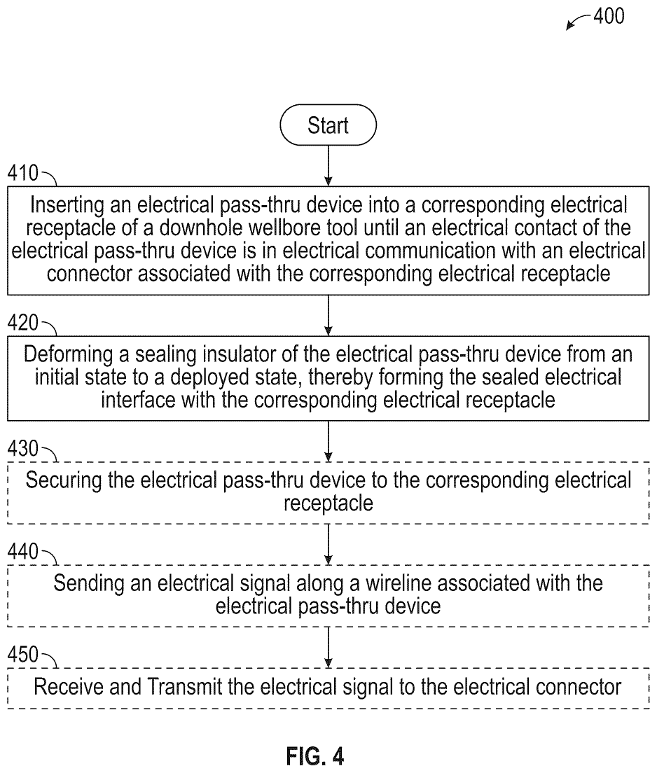

Turning now to FIG. 4, FIG. 4 is a flow chart of a method 400 for forming a sealed electrical signal interface. For example, method 400 may be used to form a sealed electrical signal interface between an electrical pass-thru device 100, 200 and an electrical receptacle 50 of a downhole wellbore tool, such that a control signal (e.g., ignition signal) may be sent to the downhole wellbore tool. In step 410, the method 400 includes inserting an electrical pass-thru device into a corresponding electrical receptacle of a downhole wellbore tool until an electrical contact of the electrical pass-thru device is in electrical communication with an electrical connector associated with the corresponding electrical receptacle. For example, method 400 may include inserting an electrical pass-thru device 100, 200 into a corresponding electrical receptacle 50 of a downhole wellbore tool. Additionally, step 410 may involve continuing insertion until an electrical contact 140, 240 of the electrical pass-thru device 100, 200 is in electrical communication (e.g., physically contacting) with an electrical connector (not pictured) of the electrical receptacle 50. It should be appreciated that a variety of suitable electrical contact 140, 240 and electrical connector configurations may be implemented to form an electrical communication channel, interface, or connection between the components.

Then, in step 420, the method 400 includes deforming a sealing insulator of the electrical pass-thru device from an initial state to a deployed state, thereby forming the sealed electrical interface with the corresponding electrical receptacle. For example, method 400 may include deforming a sealing insulator 160, 260 of the electrical pass-thru device 100, 200 from an initial state (e.g., sealing insulator 160, 260 as illustrated in FIGS. 2A and 3A) to a deployed state (e.g., sealing insulator 160′, 260′ as illustrated in FIGS. 2B and 3B). Once transitioned to the deployed state, the electrical pass-thru device 100, 200 forms the sealed electrical interface 167, 267 with the corresponding electrical receptacle 50. In an example, the sealed electrical interface is formed once a friction-fit seal is formed, which may be fluid-tight, moisture-proof, etc.

Optionally, in step 430, the method 400 includes securing the electrical pass-thru device to the corresponding electrical receptacle. For example, method 400 may include securing the electrical pass-thru device 100, 200 to the electrical receptacle 50, which may be achieved by threading on and securing a retention nut 195, 295 on one end of the body 110, 210. For example, the electrical pass-thru device may be further secured within the electrical receptacle 50 according to the techniques described above with respect to FIG. 2B and FIG. 3B.

Once the connection has been established and secured, method 400 may optionally include sending an electrical signal along a wireline associated with the electrical pass-thru device, in step 440. For example, method 400 may include sending an electrical signal along a wireline 106 associated with the electrical pass-thru device 100, 20 and/or wellbore tool. Then, method 400 may also optionally include receiving and transmitting the electrical signal to the electrical connector, in step 450. For example, method 400 may include receiving the electrical signal at the electrical pass-thru device 100, 200 and may additionally include transmitting the received electrical signal to the electrical connector (not pictured) of the electrical receptacle 50. The transmitted electrical signal may be configured to control the downhole wellbore tool, such as sending a trigger signal or an ignition signal to a perforating gun assembly.

It should be appreciated that method 400 may include more or less steps than those illustrated in FIG. 4. Furthermore, some of the steps illustrated in FIG. 4 may be repeated, rearranged to change their order, or otherwise modified according to the examples described herein and illustrated in FIGS. 1-4. 44

Examples of the above aspects include:

Example 1 is a an electrical pass-thru device for connecting with a corresponding electrical receptacle of, and transmitting an electrical signal to, a downhole tool, the device comprising: a body comprising a first end and a second end; an electrical contact at the second end configured to transmit the electrical signal through the corresponding electrical receptacle to the downhole tool; and a sealing insulator extending along and at least partially covering the body and configured to deform from an initial state to a deployed state, thereby forming a sealed interface with the corresponding electrical receptacle that is adapted to receive the electrical signal.

Example 2 includes the aspects of any preceding examples or combinations thereof and further includes the electrical pass-thru device of example 1, wherein the sealing insulator is made from an elastomeric material comprising an electrically isolating elastomer.

Example 3 includes the aspects of any preceding examples or combinations thereof and further includes the electrical pass-thru device of example 1, wherein the sealing insulator includes at least one cylindrical portion and at least two sloped portions.

Example 4 includes the aspects of any preceding examples or combinations thereof and further includes the electrical pass-thru device of example 3, wherein the at least two sloped portions include a first sloped portion and a second sloped portion, wherein the first sloped portion is sloped downward from the at least one cylindrical portion at an angle between 10 degrees and 30 degrees.

Example 5 includes the aspects of any preceding examples or combinations thereof and further includes the electrical pass-thru device of example 1, wherein the sealing insulator is over-molded onto the body.

Example 6 includes the aspects of any preceding examples or combinations thereof and further includes the electrical pass-thru device of example 1, wherein the sealing insulator is configured to maintain the sealed interface during operation of the downhole tool based on a friction fit formed between the sealing insulator and the corresponding electrical receptacle.

Example 7 includes the aspects of any preceding examples or combinations thereof and further includes the electrical pass-thru device of example 1, wherein the downhole tool is one of a perforating gun and a setting tool.

Example 8 is a method of forming a sealed electrical signal interface, the method comprising: inserting an electrical pass-thru device into a corresponding electrical receptacle of a downhole tool until an electrical contact of the electrical pass-thru device is in electrical communication with an electrical connector associated with the corresponding electrical receptacle; and wherein inserting further comprises deforming a sealing insulator of the electrical pass-thru device from an initial state to a deployed state, thereby forming the sealed electrical signal interface with the corresponding electrical receptacle.

Example 9 includes the aspects of any preceding examples or combinations thereof and further includes the method of example 8, further comprising securing the electrical pass-thru device to the corresponding electrical receptacle.

Example 10 includes the aspects of any preceding examples or combinations thereof and further includes the method of example 9, wherein the electrical pass-thru device is secured to the corresponding electrical receptacle with a retention nut.

Example 11 includes the aspects of any preceding examples or combinations thereof and further includes the method of example 9, further comprising: sending an electrical signal along a wireline associated with the electrical pass-thru device and the downhole tool; receiving the electrical signal at the electrical pass-thru device; and transmitting the received electrical signal to the electrical connector associated with the corresponding electrical receptacle, wherein the transmitted electrical signal is configured to control the downhole tool.

Example 12 is an electrical pass-thru device for connecting with a corresponding electrical receptacle of, and transmitting an electrical signal to, a downhole tool, the device comprising: a body comprising a first end, a second end, and a bore starting from the first end and extending at least partially through the body towards the second end; a movable plunger extending through the first end and partially housed within the bore; an electrical contact at the second end configured to transmit the electrical signal through the corresponding electrical receptacle to the downhole tool; and a sealing insulator extending along and at least partially covering the body and configured to deform from an initial state to a deployed state, thereby forming a sealed interface with the corresponding electrical receptacle that is adapted to receive the electrical signal.

Example 13 includes the aspects of any preceding examples or combinations thereof and further includes the electrical pass-thru device of example 12, wherein the body includes at least two insulator retention features that are configured to receive a portion of the sealing insulator and assist with retaining the sealing insulator on the body, and wherein retention features include at least one of a groove, a channel, a notch, a protrusion, and a barb.

Example 14 includes the aspects of any preceding examples or combinations thereof and further includes the electrical pass-thru device of example 12, wherein the sealing insulator is made from an elastomeric material comprising an electrically isolating elastomer.

Example 15 includes the aspects of any preceding examples or combinations thereof and further includes the electrical pass-thru device of example 12, wherein the sealed interface formed by the sealing insulator is configured to maintain the sealed interface during operation of the downhole tool based on a friction fit formed between the sealing insulator and the corresponding electrical receptacle.

Example 16 includes the aspects of any preceding examples or combinations thereof and further includes the electrical pass-thru device of example 12, wherein the body, movable plunger, and electrical contact are made from a conductive material.

Example 17 includes the aspects of any preceding examples or combinations thereof and further includes the electrical pass-thru device of example 12, wherein the downhole tool is one of a perforating gun and a setting tool.

Example 18 includes the aspects of any preceding examples or combinations thereof and further include the electrical pass-thru device of example 12, further comprising a biasing member positioned within the bore and configured to bias the movable plunger towards the first end of the body, wherein the biasing member and the movable plunger are configured to provide a deployment tolerance buffer such that the electrical pass-thru device is capable of transmitting the electrical signal while deployed within the deployment tolerance.

Example 19 includes the aspects of any preceding examples or combinations thereof and further includes the electrical pass-thru device of example 18, wherein the biasing member is a compression spring that is configured to interact with the movable plunger to maintain electrical transmissibility as a plunger head of the movable plunger advances along the deployment tolerance.

Example 20 includes the aspects of any preceding examples or combinations thereof and further includes the electrical pass-thru device of example 12, wherein the sealing insulator includes a cylindrical portion, a first sloped portion that slopes downward from the cylindrical portion by an angle α that is between 10 degrees and 30 degrees, and a second sloped portion that slopes downward from the first sloped portion by an angle β that is between 10 degrees and 30 degrees.

Certain terms are used throughout the description and claims to refer to particular features or components. As one skilled in the art will appreciate, different persons may refer to the same feature or component by different names. This document does not intend to distinguish between components or features that differ in name but not function.

For the aspects and examples above, a non-transitory computer readable medium can comprise instructions stored thereon, which, when performed by a machine, cause the machine to perform operations, the operations comprising one or more features similar or identical to features of methods and techniques described above. The physical structures of such instructions may be operated on by one or more processors. A system to implement the described algorithm may also include an electronic apparatus and a communications unit. The system may also include a bus, where the bus provides electrical conductivity among the components of the system. The bus can include an address bus, a data bus, and a control bus, each independently configured. The bus can also use common conductive lines for providing one or more of address, data, or control, the use of which can be regulated by the one or more processors. The bus can be configured such that the components of the system can be distributed. The bus may also be arranged as part of a communication network allowing communication with control sites situated remotely from system.

In various aspects of the system, peripheral devices such as displays, additional storage memory, and/or other control devices that may operate in conjunction with the one or more processors and/or the memory modules. The peripheral devices can be arranged to operate in conjunction with display unit(s) with instructions stored in the memory module to implement the user interface to manage the display of information. Such a user interface can be operated in conjunction with the communications unit and the bus. Various components of the system can be integrated such that processing identical to or similar to the processing schemes discussed with respect to various aspects herein can be performed.

While descriptions herein may relate to “comprising” various components or steps, the descriptions can also “consist essentially of” or “consist of” the various components and steps.

Unless otherwise indicated, all numbers expressing quantities are to be understood as being modified in all instances by the term “about” or “approximately.” Accordingly, unless indicated to the contrary, the numerical parameters are approximations that may vary depending upon the desired properties of the present disclosure. As used herein, “about”, “approximately”, “substantially”, and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus 10% of the particular term and “substantially” and “significantly” will mean plus or minus 5% of the particular term.

The aspects disclosed should not be interpreted, or otherwise used, as limiting the scope of the disclosure, including the claims. It is to be fully recognized that the different teachings of the aspects discussed may be employed separately or in any suitable combination to produce desired results. In addition, one skilled in the art will understand that the description has broad application, and the discussion of any aspect is meant only to be exemplary of that aspect, and not intended to suggest that the scope of the disclosure, including the claims, is limited to that aspect.

What is claimed is:

1. An electrical pass-thru device for connecting with a corresponding electrical receptacle of, and transmitting an electrical signal to, a downhole tool, the device comprising:
a body comprising a first end and a second end;
an electrical contact at the second end configured to transmit the electrical signal through the corresponding electrical receptacle to the downhole tool; and
a sealing insulator extending along and at least partially covering the body and configured to deform from an initial state to a deployed state, thereby forming a sealed interface with the corresponding electrical receptacle that is adapted to receive the electrical signal.

2. The electrical pass-thru device of claim 1, wherein the sealing insulator is made from an elastomeric material comprising an electrically isolating elastomer.

3. The electrical pass-thru device of claim 1, wherein the sealing insulator includes at least one cylindrical portion and at least two sloped portions.

4. The electrical pass-thru device of claim 3, wherein the at least two sloped portions include a first sloped portion and a second sloped portion, wherein the first sloped portion is sloped downward from the at least one cylindrical portion at an angle between 10 degrees and 30 degrees.

5. The electrical pass-thru device of claim 1, wherein the sealing insulator is over-molded onto the body.

6. The electrical pass-thru device of claim 1, wherein the sealing insulator is configured to maintain the sealed interface during operation of the downhole tool based on a friction fit formed between the sealing insulator and the corresponding electrical receptacle.

7. The electrical pass-thru device of claim 1, wherein the downhole tool is one of a perforating gun and a setting tool.

8. A method of forming a sealed electrical signal interface, the method comprising:
inserting an electrical pass-thru device into a corresponding electrical receptacle of a downhole tool until an electrical contact of the electrical pass-thru device is in electrical communication with an electrical connector associated with the corresponding electrical receptacle; and
wherein inserting further comprises deforming a sealing insulator of the electrical pass-thru device from an initial state to a deployed state, thereby forming the sealed electrical signal interface with the corresponding electrical receptacle.

9. The method of claim 8, further comprising securing the electrical pass-thru device to the corresponding electrical receptacle.

10. The method of claim 9, wherein the electrical pass-thru device is secured to the corresponding electrical receptacle with a retention nut.

11. The method of claim 9, further comprising:
sending an electrical signal along a wireline associated with the electrical pass-thru device and the downhole tool;
receiving the electrical signal at the electrical pass-thru device; and
transmitting the received electrical signal to the electrical connector associated with the corresponding electrical receptacle, wherein the transmitted electrical signal is configured to control the downhole tool.

12. An electrical pass-thru device for connecting with a corresponding electrical receptacle of, and transmitting an electrical signal to, a downhole tool, the device comprising:
a body comprising a first end, a second end, and a bore starting from the first end and extending at least partially through the body towards the second end;
a movable plunger extending through the first end and partially housed within the bore;
an electrical contact at the second end configured to transmit the electrical signal through the corresponding electrical receptacle to the downhole tool; and
a sealing insulator extending along and at least partially covering the body and configured to deform from an initial state to a deployed state, thereby forming a sealed interface with the corresponding electrical receptacle that is adapted to receive the electrical signal.

13. The electrical pass-thru device of claim 12, wherein the body includes at least two insulator retention features that are configured to receive a portion of the sealing insulator and assist with retaining the sealing insulator on the body, and wherein retention features include at least one of a groove, a channel, a notch, a protrusion, and a barb.

14. The electrical pass-thru device of claim 12, wherein the sealing insulator is made from an elastomeric material comprising an electrically isolating elastomer.

15. The electrical pass-thru device of claim 12, wherein the sealed interface formed by the sealing insulator is configured to maintain the sealed interface during operation of the downhole tool based on a friction fit formed between the sealing insulator and the corresponding electrical receptacle.

16. The electrical pass-thru device of claim 12, wherein the body, movable plunger, and electrical contact are made from a conductive material.

17. The electrical pass-thru device of claim 12, wherein the downhole tool is one of a perforating gun and a setting tool.

18. The electrical pass-thru device of claim 12, further comprising a biasing member positioned within the bore and configured to bias the movable plunger towards the first end of the body, wherein the biasing member and the movable plunger are configured to provide a deployment tolerance buffer such that the electrical pass-thru device is capable of transmitting the electrical signal while deployed within the deployment tolerance.

19. The electrical pass-thru device of claim 18, wherein the biasing member is a compression spring that is configured to interact with the movable plunger to maintain electrical transmissibility as a plunger head of the movable plunger advances along the deployment tolerance.

20. The electrical pass-thru device of claim 12, wherein the sealing insulator includes a cylindrical portion, a first sloped portion that slopes downward from the cylindrical portion by an angle α that is between 10 degrees and 30 degrees, and a second sloped portion that slopes downward from the first sloped portion by an angle β that is between 10 degrees and 30 degrees.
